(19) United States
(12) Patent Application Publication
(10) Pub. No.: US 2006/0103943 A1
(43) Pub. Date: May 18, 2006

(54) Radiation focussing element

(76) Inventors: Gavin R. Erry, Albuquerque, NM (US); Paul Harrison, Albuquerque, NM (US); Andrew M. Scott, Worcestershire (GB)

Correspondence Address: NIXON & VANDERHYE, PC, 901 NORTH GLEBE ROAD, 11TH FLOOR, ARLINGTON, VA, 22203, US

(21) Appl. No.: 10/539,085

(22) PCT Filed: Dec. 12, 2003
(86) PCT No.: PCT/GB03/05463

§ 371 Date: Jul. 26, 2005

(30) Foreign Application Priority Data
Dec. 17, 2002 (GB) 0229290.2

(51) Int. Cl. G02B 3/00

(52) U.S. Cl. 359/642

(57) ABSTRACT

The or at least one surface of a reflective or transmissive radiation focussing element is provided with at least one phase or amplitude diffraction grating that is distorted substantially according to a quadratic function. The surface or the opposed surface may also be provided with an aperture. The element is useful in three dimensional imaging and wavefront sensing systems.

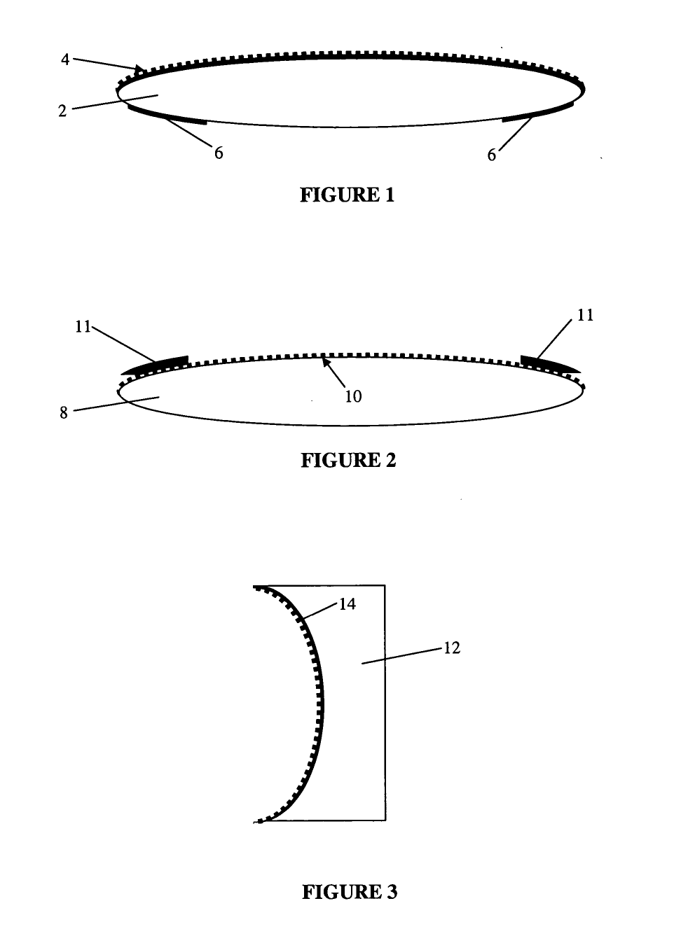

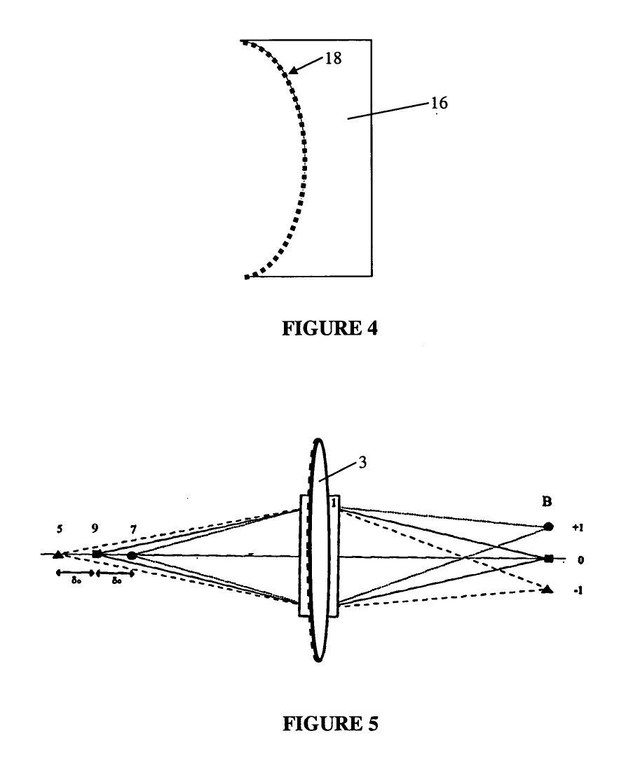

The present invention relates to a radiation focussing element.

International Patent Application No. WO/46768 (Secretary of State for Defence) describes an imaging system which includes a diffraction grating which is distorted substantially according to a quadratic function to cause images to be formed under varying focus conditions. Our copending UK Patent Application No. 0205240.5 relates to a system for determining data relating to the local shape (or local phase distribution) of a radiation wavefront, and certain embodiments of that apparatus comprise such a distorted diffraction grating.

Although particularly described in the context of optical radiation, these systems may be used with other forms of radiation.

Both of these patent applications show apparatus in which the distorted grating is located adjacent to a lens.

In a first aspect the present invention provides a radiation focussing element at least one surface of which is provided with at least one diffraction grating which is distorted substantially according to a quadratic function. Preferably the focussing element is or comprises a lens which is transmissive to the radiation (a dioptric element), for example a lens of glass, or a glassy material, although it could also be (for example) of a polymeric material; alternatively the focussing element is or comprises a focussing reflector (a catoptric element).

In a preferred embodiment of the invention a single grating is disposed on only one surface of the focussing element. However, according to requirements, different gratings may be disposed on different areas of the same surface of the focussing element, and/or (when the focussing element is a transmissive lens) a similar or different grating or gratings may be disposed on the opposed lens external surface.

In one embodiment the grating is a phase grating. It may be formed in the surface of the bulk (reflective or transmissive) element itself, for example by embossing or selective etching of the formed element, or by suitably moulding or otherwise shaping the element during manufacture.

Alternatively the grating may be formed in a layer covering at least part of the surface of the element, for example a layer made of a polymeric material or a glassy composition in which the grating is embossed or selectively etched.

Our copending UK Patent Application No. 0123744.5 describes and claims a method of providing an optical substrate with a surface having a desired shape, the method comprising the steps of coating the surface with a thin layer of an optical glass, and subsequently modifying the shape of the external surface of the layer. As disclosed therein, the shaping of the glass layer may be imparted by etching or embossing. The glass layer may be of a chalcogenide glass, for example a glass consisting of Ge, As, Se and Te, which is rich in Te, or amorphous arsenic trisulphide. It may be deposited by RF sputtering, flash evaporation, solvent evaporation or spin coating.

Furthermore, alternative processes may be utilised to form the grating, for example by coating of the surface of the focussing element with a photoresist, followed by exposure to interfering light beams, development of the resist pattern, and selective etching prior to removal of the remaining resist. In some cases, the developed resist pattern may itself provide the grating without the need for etching.

Where the focussing element is a transparent lens a layer in which the grating is formed should be transmissive. Where the focussing element is reflective, the layer could again be transmissive; alternatively the grating could be formed in a reflective layer on a suitably shaped substrate so that the layer provides both the focussing and grating functions.

In a development of the invention, e.g. where the size of the beam is important, an amplitude mask is located on at least one surface of the focussing element to provide an aperture. Thus in our copending UK Patent Application No. 0205240.5 mentioned above, the focussing and diffractive elements are located closely adjacent an aperture.

Such a mask could be provided in an additional layer of radiation (light) obscuring material on the said surface, either by selective deposition or selective removal, for example. Thus, whether the grating is a phase grating or an amplitude grating, it could be provided by a suitably shaped layer on the surface of the focussing element.

In another embodiment of the invention, the, each, or at least one of the phase gratings described above in relation to the invention is replaced by an amplitude grating. Again, this could be provided in an additional layer of radiation (light) obscuring material on a surface of the focussing element, either by selective deposition or selective removal, for example. Where the aperture mask is also present, the grating and mask may be deposited sequentially or simultaneously, and they may be on the same surface or opposed surfaces of the focussing element.

The invention extends to a three-dimensional imaging system or a wavefront sensor comprising an optical element according to the first aspect of the invention.

The systems described in the aforementioned International Patent Application No.

WO/46768 and UK Patent Application No. 0205240.5 are prone to chromatic aberration due to the dispersive properties of the grating, and this has been a limiting factor when attempting to apply the technology with broadband or white light. Accordingly in a preferred embodiment of lens focussing element, the dispersion inherent in the grating is reduced, and more preferably substantially compensated for, by the lens itself, or one or more refractive element(s) thereof if it is a compound or composite lens. This enables the compound element to be used in a white light wavefront sensor or imaging system, for example in systems of the type described and claimed in our aforesaid patent applications.

By forming the grating on the surface of the focussing element, a composite optical element is formed which performs both the grating and focussing functions but which is not prone to misalignment problems between the focussing element and the grating due to shocks or other environmental factors. This advantage is compounded if an aperture is also required and it is also provided on the focussing element itself

1. A radiation focussing element having at least one surface provided with at least one diffraction grating that is distorted substantially according to a quadratic function.

2. A focussing element according to claim 1 wherein the focussing element surface comprises a radiation reflector.

3. A focussing element according to claim 1 wherein the focussing element surface comprises a radiation transmissive material.

4. A focussing element according to claim 3 wherein only one surface of the lens is provided with a said grating.

5. A focussing element according to claim 3 wherein dispersion inherent in the grating is reduced by the lens itself, or by at least one refractive element.

6. A focussing element according to claim 1 wherein the grating is a phase grating.

7. A focussing element according to claim 1 wherein the grating is an amplitude grating.

8. A focussing element according to claim 1 wherein the grating is provided in a layer covering at least part of said surface.

9. A focussing element according to claim 8 wherein said layer is made of a glassy composition.

10. A focussing element according to claim 8 wherein said layer is made of a radiation obscuring material.

11. A focussing element according to claim 8 wherein said layer is shaped.

12. A focussing element according to claim 2 wherein the reflector comprises a reflective layer on a substrate, and said reflective layer is shaped to provide said grating.

13. A focussing element according to claim 1 wherein the grating is provided in the surface of the bulk element itself.

14. A focussing element according to claim 1 and further comprising a mask on at least one surface of the element to provide an aperture.

15. A focussing element according to claim 14 wherein a said mask is provided in a layer on a single surface of the focussing element.

16. A focussing element according to claim 14 wherein said mask and said grating are provided on the same surface of the focussing element.

17. A transmissive focussing element according to claim 14 wherein said mask and said grating are provided on the opposed surfaces of the focussing element.

18. A radiation focussing element according to claim 1 for use with optical radiation.

19. A method of making an element according to claim 11 wherein the grating is formed by embossing.

20. A method of making an optical element according to claim 11 wherein the grating is formed by selective etching.

21. A method of making an optical element according to claim 6 wherein the focussing element is a transmissive lens and the grating is formed by moulding during manufacture of the lens.

22. A three-dimensional imaging system comprising an element according to claim 1.

23. A wavefront sensor comprising an optical element according to claim 1.
